(19) United States
(12) Patent Application Publication
(10) Pub. No.: US 2026/0001631 A1
(43) Pub. Date: Jan. 1, 2026

(54) WATERBORNE PAYLOAD TRANSPORT

(71) Applicant: USA AS REPRESENTED BY THE SEC OF THE NAVY, San Diego, CA (US)

(72) Inventors: Ralph David Hooper, Lemon Grove, CA (US); William Chambers, Jamul, CA (US); Taylor Doolittle, San Diego, CA (US); Daniel Codd, San Diego, CA (US)

(73) Assignee: USA AS REPRESENTED BY THE SEC OF THE NAVY, San Diego, CA (US)

(21) Appl. No.: 18/757,133

(22) Filed: Jun. 27, 2024

(51) Int. Cl. B63B 35/44; B63B 35/00

(52) U.S. Cl. CPC B63B 35/44; B63B 35/003

(57) ABSTRACT

The multiple embodiments of the present invention involve a waterborne payload transport system that includes a trolley system that moves a crane along a track. The crane is adapted to engage a waterborne payload, lift the payload and place the payload in a stowage cradle. The waterborne payload transport system may be modularized allowing for disassembly and compact transportation.

### FEDERALLY-SPONSORED RESEARCH AND DEVELOPMENT

The United States Government has ownership rights in the invention claimed herein. Licensing and technical inquiries may be directed to the Office of Research and Technical Applications, Naval Information Warfare Center Pacific, Code 72120, San Diego, CA, 92152; voice (619) 553-5118; NIWC_Pacific_T2@us.navy.mil. Reference Navy Case Number 211329.

### BACKGROUND OF THE INVENTION

Watercraft, for millennia, have been used to traverse and transport payloads across oceans, seas and rivers. The economics and mission requirements for such watercraft have played a role in their design and implementation. At times, multiple watercraft have worked together to where one watercraft transports another watercraft either by being carried within one's hull or by towing.

It may be both economically or mission requirement beneficial to tow a vehicle or payload as opposed to storing such vehicle in the hull of another. Such benefits may include elimination of loading time and having a larger selection of towing watercraft for the towed vehicle or payload. Existing towing apparatus and methods would benefit from continued improvement.

### SUMMARY

In an embodiment, the present invention relates to a waterborne payload transport system comprising a floating platform, a trolley system having at least one track coupled to the floating platform, and a crane element having at least one arm, the crane element moveably coupled to the trolley system.

In another embodiment, the present invention relates to a method of operating a waterborne payload transport system comprising maneuvering a floating platform in proximity to a waterborne payload, engaging a crane element to couple the crane element to the waterborne payload, lifting the payload out of a liquid body, and fastening the payload to a stowage cradle.

In another embodiment, the present invention relates to a method of assembling and disassembling a waterborne payload transport system comprising coupling at least one beam to a floatation element, coupling a trolley system to one or more of the beam or the floatation element, and coupling a crane element to the trolley system.

### BRIEF DESCRIPTION OF THE DRAWINGS

Throughout the several views, like elements are referenced using like references. The elements in the figures are not drawn to scale and some dimensions are exaggerated for clarity.

FIG. 1 is a perspective view of a waterborne payload transport system and payload according to an embodiment of the present disclosure.

FIG. 2 is a perspective view of several elements of waterborne payload transport system, according to an embodiment of the present disclosure.

FIG. 3 is a top view of the several elements of a waterborne payload transport system in FIG. 2, according to an embodiment of the present disclosure.

FIG. 4 is a front view of several elements of a waterborne payload transport system in FIG. 2, according to an embodiment of the present disclosure.

FIG. 5 is a side view of a waterborne payload transport system in FIG. 2 according to an embodiment of the present disclosure.

FIG. 6 is a perspective view a beam of the waterborne payload transport system according to an embodiment of the present disclosure.

FIG. 7 is a perspective view of a base frame of a waterborne payload transport system according to an embodiment of the present disclosure.

FIG. 8 is a perspective view of a crane element of a waterborne payload transport system according to an embodiment of the present disclosure.

FIG. 9 is frontal view of the crane element in FIG. 8 according to an embodiment of the present disclosure.

FIG. 10 is a perspective view a stowage cradle of the waterborne payload transport system according to an embodiment of the present disclosure.

FIG. 11 is a perspective view of a shock isolator according to an embodiment of the present disclosure.

FIG. 12 is a perspective view of multiple elements of the waterborne payload transport system on a pallet according to an embodiment of the present disclosure.

FIG. 13 is a perspective view of a waterborne payload transport system and walkway panels according to an embodiment of the present disclosure.

FIG. 14 is a flowchart illustrating the steps for operating a waterborne payload transport system, according to an embodiment of the present disclosure.

FIG. 15 is a flowchart illustrating the steps for assembling and disassembling a waterborne payload transport system, according to an embodiment of the present disclosure.

### DETAILED DESCRIPTION OF EMBODIMENTS

The disclosed methods and systems below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically. Additionally, the terminology used herein is for the purpose of description and not of limitation. Furthermore, although certain methods are described with reference to steps that are presented herein in a certain order, in many instances, these steps may be performed in any order as may be appreciated by one skilled in the art; the novel method is therefore not limited to the particular arrangement of steps disclosed herein.

It must be noted that as used herein and in the appended claims, the singular forms “a”, “an”, and “the” include plural references unless the context clearly dictates otherwise. Furthermore, the terms “a” (or “an”), “one or more” and “at least one” can be used interchangeably herein. The terms “comprising”, “including”, “having” and “constructed from” can also be used interchangeably.

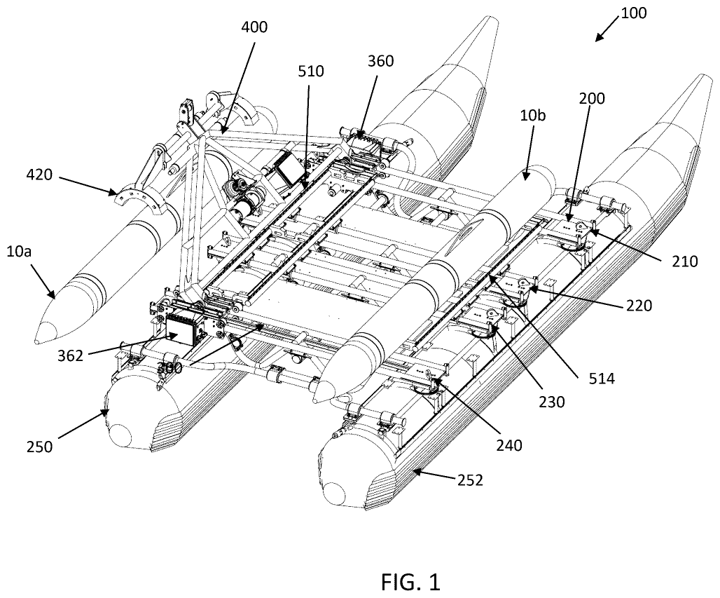

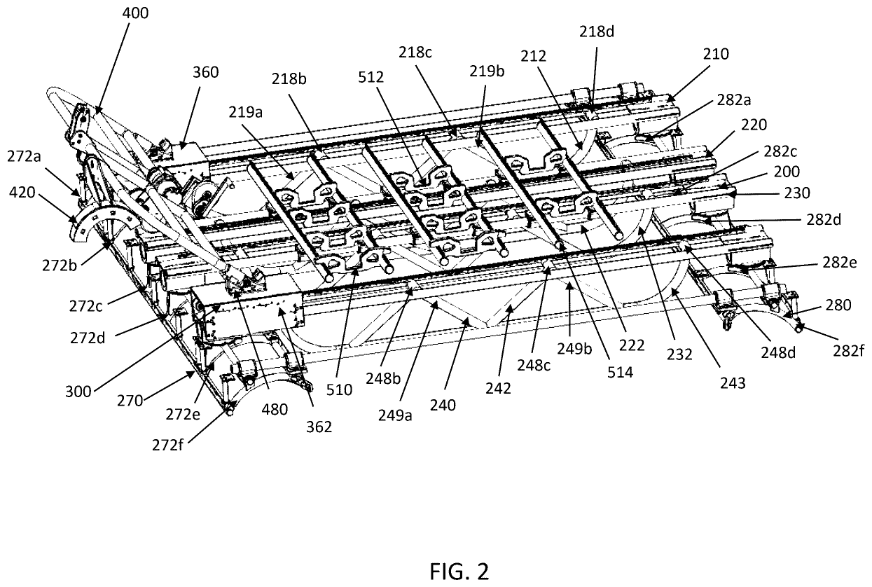

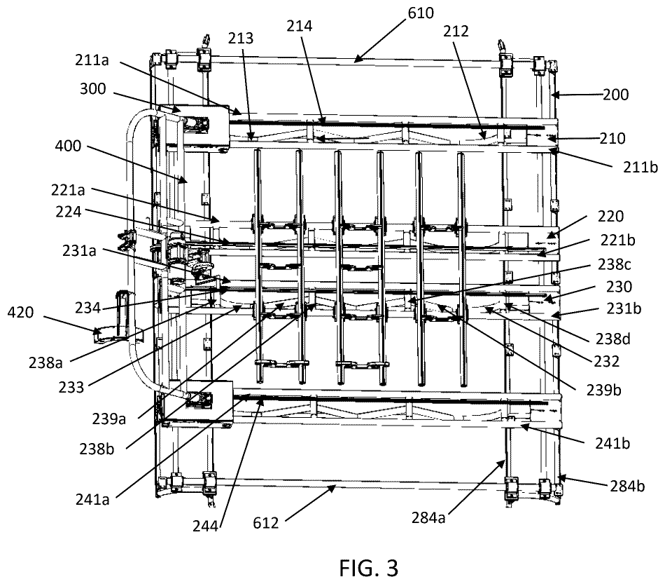

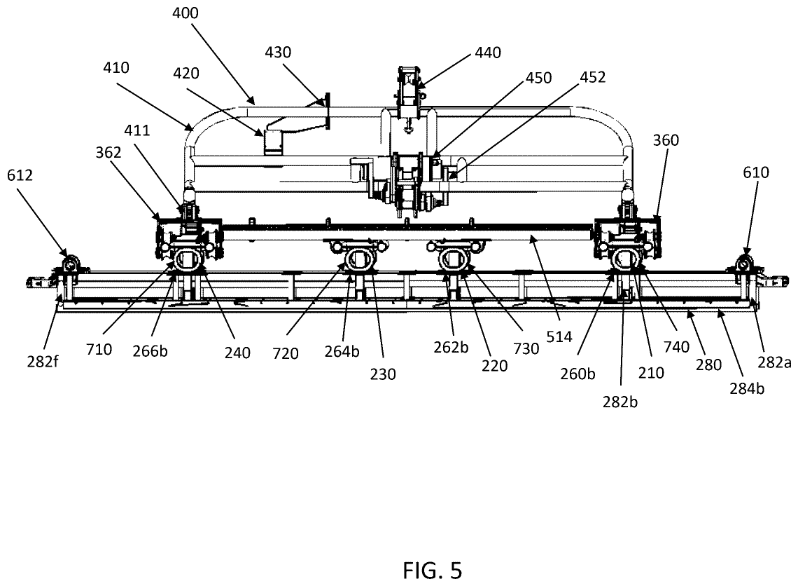

Referring to FIG. 1 and FIG. 2, a waterborne payload transport system 100 may comprise a floating platform 200, a trolley system 300 and a crane element 400. The floating platform 200 may comprise at least one beam 210, 220, 230, 240, at least one base frame 270, 280 and at least one flotation element 250, 252. The floatation elements 250, 252 may be inflatable. In an embodiment, the floating platform 200 comprises two or more beams 210, 240 and in another embodiment comprises four beams 210, 220, 230, 240. In an embodiment, the floating platform includes two floatation elements and two base frames. Each beam 210, 220, 230, 240 may extend from one flotation element 250, to another flotation element 252. As best shown in FIG. 3, the floating platform 200 may include a front brace 610 and a rear brace 612, each generally extending a majority of the length between a port and a starboard side of the floating platform. Also referring to FIG. 2 and FIG. 5, shock isolators 710, 720, 730, 740 may be located between beams 210, 220, 230, 240 and flotation element 252. Similarly, shock isolators may be located between beams 210, 220, 230, 240 and flotation element 250. Shock isolators may be fastened to base frames 270, 280. The shock isolators reduce shock and vibration from transferring from the flotation elements 250, 252 into a payload 10a, the trolley system 300 and crane element 400.

As shown in FIG. 1, a payload 10a is in a raised position above the water by crane element 400 and may be lowered from this position into the water or may be moved to one of stowage cradles 510, 512 to be fastened for transport. Payload 10b is fastened to stowage cradle 514. Payload 10b may be unfastened from stowage cradle 514 and lifted from stowage cradle 514 by crane element 400 and moved by trolley system 300 to a position above the ambient water where it may then be lowered into the water by crane element 400.

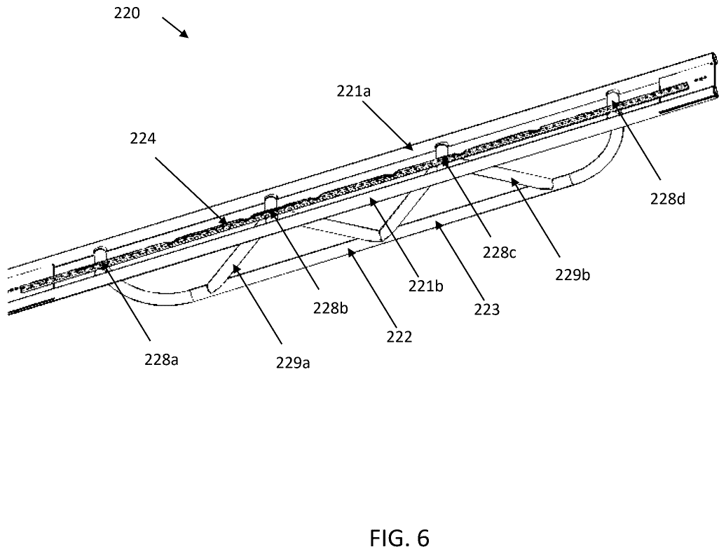

Referring to FIGS. 1, 2, 3, and 6, each beam 210, 220, 230, 240 may include a pair of rods 211a, 211b, 221a, 221b, 231a, 231b, 241a, 241b that are generally parallel to each other and extend along a majority of the span between flotation elements when installed. Each of the rods provide structural support in tension, torsion and compression. The rods support buffeting from waves including when tied up for example to a pier to reduce slam loading. The buffeting may occur in a number of directions include in a front-to-back alignment with the floating platform 200 or perpendicular to the floating platform 200. In an embodiment, a track 214, 224, 234, 244 may be disposed between each of the rods 211a, 211b, 221a, 221b, 231a, 231b, 241a, 241b, respectively and each of the tracks may extend a majority of the length between a pair of flotation elements 250, 252 when installed. A side of each of beams 210, 220, 230, 240 may be fastened to a base frame 270, 280. Each beam 210, 220, 230, 240 may further comprise a supporting web 212, 222, 232, 242 which may be coupled to each of a respective rods 211a, 211b, 221a, 221b, 231a, 231b, 241a, 241b. As best illustrated with beams 220, 240 in FIG. 2 and FIG. 6, each web 212, 222, 232, 242 may have a base 213, 223, 233, 243 that have curved ends that extend outwards and upward and terminate at a beam coupler 218d, 228a, 228d, 238a, 238d, 248d. Each web may include one or more, e.g. two, trusses that are inverted V-joints 219a, 219b, 229a, 229b, 239a, 239b, 249a, 249b that at an upper apex joins a respective pair of beams at a beam coupler 218b, 218c, 228b, 228c, 238b, 238c,248b, 248c, and lies between end beam couplers 218d, 228a, 228d, 238a, 238d, 248d. respectively, and at each of the inverted V-joint's lower ends terminate at the base 213, 223, 233, 243, respectively.

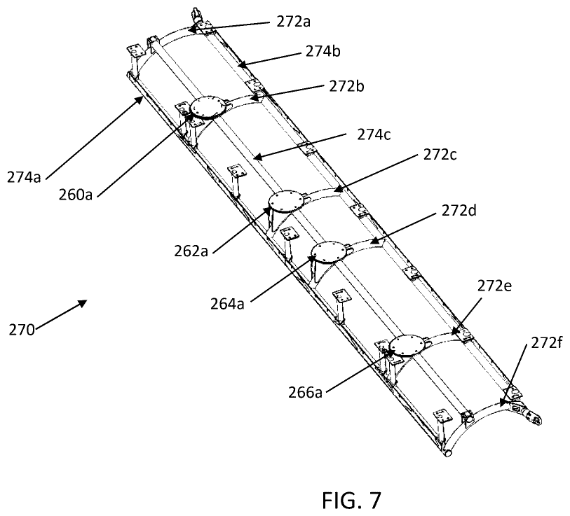

Referring also to FIG. 7, the floating platform 200 may further include a base frame, and in an embodiment includes a pair of base frames 270, 280 that each include a plurality of lateral joists 272a, 272b, 272c, 272d, 272e, 272f, 282a, 282b, 282c, 282d, 282e, 282f that are complimentary in shape to a top portion of a flotation element. The lateral joists may be uniformly spaced-apart along the length of a respective base frame. In an embodiment, any of inner lateral joists 272b, 272c, 272d, 272e, 272f, 282b, 282c, 282d, 282e may have a closer spacing to another inner lateral joist than the spacing of an inner lateral joist to the outer later joists 272a, 272f, 282a 282f to better align the inner lateral joists for load bearing support to the payload which may be attached at or near the center of the waterborne payload transport system 100.

The base frames 270, 280 may further each include at least two longitudinal linkages 274a, 274b, 284a, 284b that may fasten to at least two of the respective lateral joists 272a, 272b, 272c, 272d, 272e, 272f, 282a, 282b, 282c, 282d, 282e, 282f. The complimentary shape of the joists provide an optimal or substantially high amount of surface contact with the flotation elements over their length such that in an embodiment, ninety percent or greater of the length of a joist is in contact with a respective flotation element. The linkages 274a, 274b, 284a, 284b may generally be two-force members and can include a bar or pole. In an embodiment, the linkages 274a, 274b, 284a, 284b couple the joists at or near the end of each joist, may lie on a top side of a flotation element 250, 252 and may restrict relative movement of the joists so as to secure the linkages and multiple joists to the flotation element. In an embodiment, a third linkage 274c lies between outer linkages 274a, 274b.

A base frame 270, 280 may further include a plurality of mounts for fastening a beam 210, 220, 230, 240 through, as best shown in FIG. 5 and FIG. 7, plates 260a, 260b, 262a, 262b, 264a, 264b, 266a, 266b. Plates 260a, 260b, 262a, 262b, 264a, 264b, 266a, 266b may lie on an upper majority of the base frame 270, 280 so as to provide a higher installation of beams 210, 220, 230, 240 as compared to a lower majority. In this way, beam support elements may be situated higher and thus experience less incidence of waves when the waterborne payload transport system 100 is towed. In an embodiment, base frames 270, 280 are detachably coupled to a flotation element 250, 252. In an embodiment, one or more of base frames 270, 280 is detachably coupled to one or more of beams for example, through nuts and bolts, slotted retention, magnets or through clamping.

The flotation elements 250, 252 may include pontoons. The pontoons may be sized such that when inflated, the flotation elements 250, 252 are able to raise the payload and beams above a waterline to reduce buffeting of water onto the payload and beams when the waterborne payload transport system 100 is towed. The front facing side of the flotation elements 250, 252 as determined by the direction of the tow, may be aerodynamically shaped, including rounded or pointed edges, to reduce drag.

Referring to FIGS. 2 and 3, in an embodiment, the trolley system 300 may comprise one or more tracks 214, 224, 234, 244 and at least one motor 360, 362. The tracks 214, 224, 234, 244 may be fastened to the floating platform 200 through the beams 210, 220, 230, 240 and utilizing the beams as a support structure. In an embodiment, the tracks 214, 224, 234, 244 have a support structure independent of the beams and may be directly coupled to the floatation elements 250, 252. In an embodiment, the tracks 214, 224, 234, 244 are detachably coupled to the beams for example, through nuts and bolts, slotted retention, magnets or through clamping. Motors 360, 362 in one embodiment, engage a track 214, 224, 234, 244 and can move the crane element 300 along the track. The motor 360, 362 may be a rotary motor that has a gear that drives along a track 214, 224, 234, 244 with teeth such that the gear can moveably engage the track. In an embodiment, one or more motors each are coupled to a pair of tracks.

In an embodiment, the crane element 400 may include one or more of an arm 410, a holder 420, a holder pulley 430, a holder winch 440, an arm pulley system 450 and an arm winch 460. In an embodiment, the arm 410 may extend away and upwards above the motor. When the waterborne payload transport system 100 is in operation, the flotation elements 250, 252 raise the crane element 400 above the water. Upward is generally determined as the direction away from the water. The holder 420 is adapted to interface and hold a payload such that it can lift the payload out of the water or alternately lower the payload into the water. The holder 420 may be coupled at or near the end of the arm 410 and may lie within twenty percent of the most outboard or highest portion of the arm 410. In an embodiment, the holder 420 has a portion that is complimentary in shape to a portion of a payload that the holder 420 contacts. The complimentary shape provides increased surface area and force distribution so as to reduce any potential damage to a payload. In an embodiment, the crane element 400 and/or arm 410 is moveably coupled at its base 411.

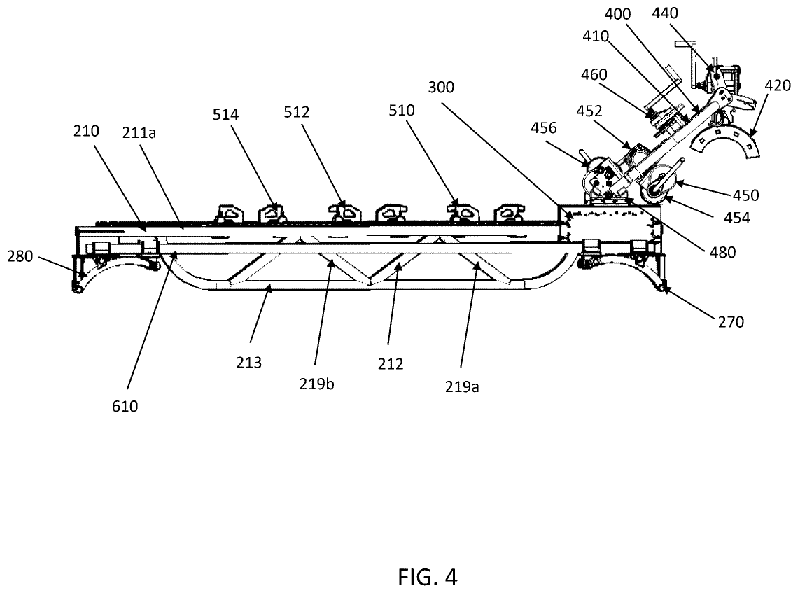

Referring to FIGS. 2, 4, 5 and 8, the crane element 400 can be moveably coupled to the trolley system 300 and includes being coupled to a motor 360, 362 or to a track 214, 224, 234, 244. In an embodiment, moveably coupled can be a pivotal or rotatable coupling where rotation occurs about an axis such that an end of the arm 410 can move between an upper position to a lower position and vice versa. In another embodiment, moveably coupled can be linearly translatable coupling such as moving along the length of any of tracks 214, 224, 234, 244. In the embodiment where the arm 410 is coupled to one of more of motors 360, 362, the arm 410 may be coupled at base 411 may be pivotally connect at a side of one or more motor 360, 362 or motor housing or at the top of one or more of motor 360, 362 or motor housing. In another embodiment, the motors 360, 362 remains stationary and drives a chain or pulley system to move the arm 410 along one or more tracks 214, 224, 234, 244. The crane element 400 may be detachably coupled to the trolley system, for example, through nuts and bolts, slotted retention, magnets or through clamping.

A stopper 480 may be used to limit the rotation of arm 410. In an embodiment, the stopper 480 limits the rotation of the arm 410 in combination with the crane element's position on the track 214, 224, 234, 244 such that the holder 420 of the crane element 400 can be disposed vertically clear from any of the flotation elements 250, 252 and generally above a waterborne payload. The crane element's position may be within twenty percent of the most outboard portion of any of tracks 214, 224, 234, 244. The angle of the arm 410 of the crane element 400 may be from twenty to sixty degrees and in another embodiment the angle may range from thirty to fifty degrees. When a payload is lifted or lowered, the payload will avoid bumping into any of the flotation elements, beams or linkages and thus avoid damage.

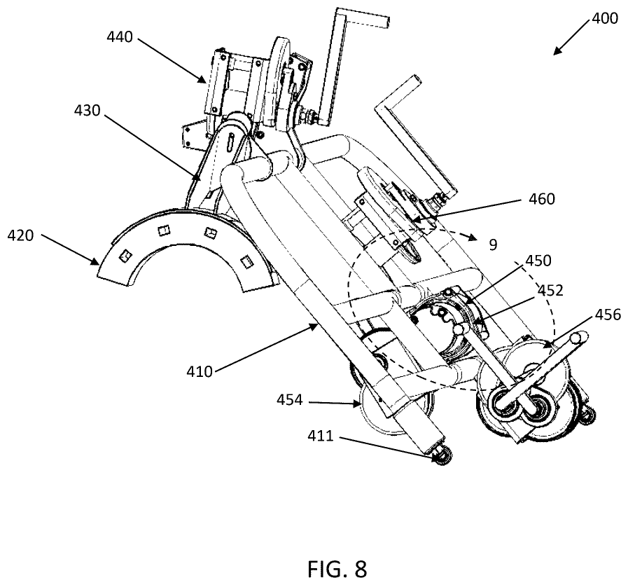

Referring again to at least FIG. 8, in an embodiment, the crane element 400 the holder winch 440 may be located at or near the top of the arm or may be located along the height of the arm. The holder pulley 430 may be located within upper thirty percent of the arm 410 and in an embodiment is located within the upper ten percent of the arm 410. A line may extend from the holder winch 440 through the holder pulley 430 and terminates at the 420 holder. The holder winch 440 may be used extend line or draw line in to respectively lower or raise a payload fastened to the holder 420.

In an embodiment, the arm winch 460 when actuated is used to rotate the arm 410 to raise or lower the arm 410 such that the arm raises or lower a payload when fastened to the holder 420. The arm winch 460 may be located in the upper half of the arm 410 the location of which would allow for a beneficial ergonomic height for manual cranking of the arm winch 460 by an operator. The arm pulley system 450 may comprise one or more pulleys that in combination creates a lever arm to rotate arm 410. In an embodiment, the arm pulley system 450 includes a base pulley 452, a front pulley 454 and a locking pawl 456. Base pulley 452 may be motorized to cause arm 410 to raise or lower. The arm winch 460 and pulley system 450 alone or in combination with stopper 480 may hold the arm 410 at an angle from twenty to sixty degrees and in another embodiment the angle may range from thirty to fifty degrees.

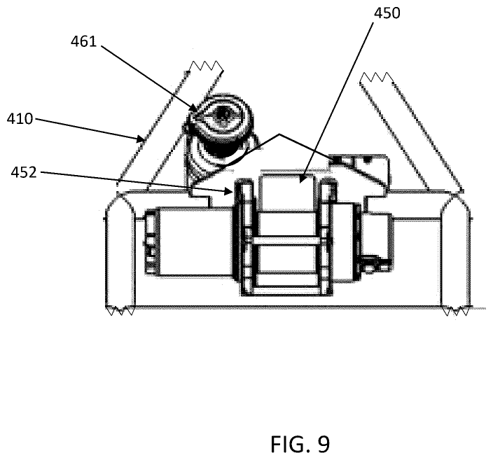

Referring to FIG. 9, in an embodiment a second manual backup winch 461 may be used to raise or lower arm 410. Much like arm winch 460, manual backup winch 461 when actuated is used to rotate the arm 410 to raise or lower the arm 410 such that the arm raises or lower a payload when fastened to the holder 420. Manual backup winch may be used as an alternative to a motorized base pulley 452 and arm winch 460.

The waterborne payload transport system 100 may include a tow interface that allows a towing vehicle to attach a towline to the waterborne payload transport system such that it may be towed. The tow interface may be an eyelet or a cleat, and may be at the front of the floating platform 200 and in one embodiment, is located on one of the beams 210, 220, 230, 240. In an embodiment, the eyelet or cleat is located on a mid-thirty percent of the mid-span of a forwardmost beam 210. In another embodiment, the tow interface may be an eyelet or a cleat located at a side location of the floating platform 200 and in an embodiment the eyelet or cleat is located on any of the floatation elements 250, 252, base frames 270, 280, beams 210, 220, 230, 240 or linkages 274a, 274b, 284a, 284b. With the tow interface located on the side of the waterborne payload transport system, the waterborne payload transport system is adapted to be side-towed by a towing craft or front towed if multiple side-located eyelets and/or cleats are used.

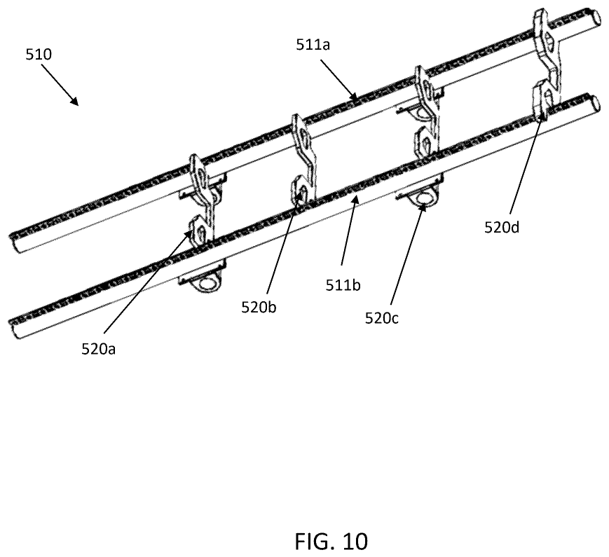

Referring to FIGS. 2, 4 and 10, the waterborne payload transport system may include one or more stowage cradles 510, 512, 514 adapted to receive a payload 10a, 10b and secure the payload. In an embodiment, a stowage cradle 510, 512, 514 is adapted to be fastened to at least one or more beams 210, 220, 230, 240. As best shown in FIG. 10 with regards to stowage cradle 510, a stowage cradle 510 may be comprised of a pair of channels 511a, 511b. Each of such stowage cradles may have an upper surface whose shape has a portion that is complimentary to the shape of a portion of the payload, such that the force distribution of the payload is spread over the surface of a channel, when a payload is placed upon a stowage cradle. In another embodiment, support blocks 520a, 520b, 520c, 520d each of which have an upper surface whose shape has a portion that is complimentary to the shape of a portion of the payload may be used. Multiple stowage cradles 510, 512, 514 may be attached to an upper side of the floating platform and in an embodiment, three stowage cradles are located on an upper surface of the floating allowing for three underwater unmanned vessels to be stowed on the stowage cradles.

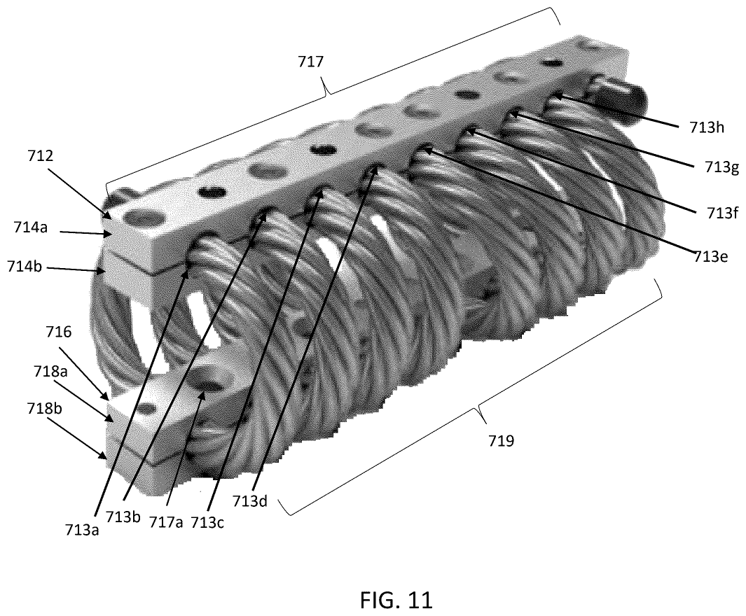

FIG. 11 illustrates shock isolator 710 in isolation. Shock isolators 710, 720, 730, 740 each include a top bar 712 and a lower bar 716. Each bar 712, 716 comprises multiple horizontal orifices 713a, 713b, 713c, 713d, 713e, 713f, 713g, 713h, 717a through which a metal wire rope may pass through. In an embodiment, bars 712 and 716 each have a plurality of paired and aligned horizontal orifices between the two bars. In an embodiment, multiple rings 719 of a single coil passes through each of the orifices 713a, 713b, 713c, 713d, 713e, 713f, 713g, 713h, 717a, with a ring passing through a respective pair of orifices between each bar, i.e a single ring passes through an orifice in top bar 712 and lower bar 716. In an embodiment, each of rings 719 are individual elements and are not parts of an individual coil. In an embodiment, bars 712, 716 are coupled with a combination of individual rings and one or more coils. In the embodiment, any one of rings 719 may be constructed of multiple metal or alloy fibers.

Top bar 712 and lower bar 716 may be constructed from two segments, an upper segment 714a, 718a and a lower segment 714b, 718b, respectively, where the upper segment 714a of top bar 712 generally forms a planar surface. The planar surface provides an optimized surface area for load transfer from the payload to a shock isolator. Each bar 712, 716 may have one or more vertical orifices 717 that allow upper segments 714a, 718a to be fastened to a lower segments 714b, 718b, respectively. The orifices 717 may be concave or beveled to compliment the shape of the bottom of a fastener head and allowing for the head of a fastener to lie flush with a surface of a segment 714a, 714b, 718a, 718b. The fastener may comprise a nut and bolt combination. The bolt may lie flush or below the surface of a bar segment 714a, 714b, 718a, 718b. In an embodiment, the nut and bolt combination may be arranged in an alternating and inverted pattern in the top bar 712 and lower bar 716 such that in a segment 714a, 714b, 718a, 718b the head of fastener lies between two bolts and vice versa. This alternating pattern achieves load balancing between the heads of the fasteners and the bolts which may be important if the load bearing surfaces of the heads and the bolts are different. The alternating pattern may be staggered between the upper segment 714a of the top bar 712 and the top segment 718a of the lower bar 716. In an embodiment, the top bar 712 and lower bar 716 are monolithic in structure. While shock isolators 710, 720, 730, 740 are shown and described as being on the starboard side of the waterborne payload transport system 100, shock isolators may also be located at other points along the span of beams 210, 220, 230, 240 including the port side and the mid-portion.

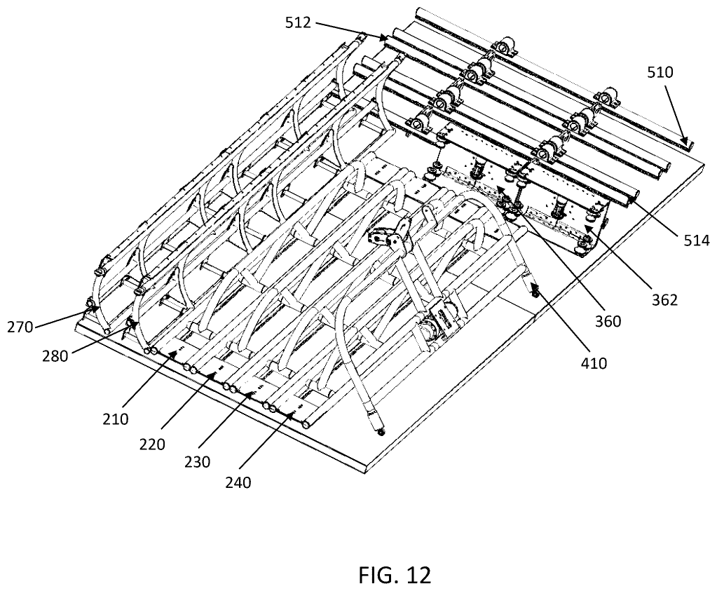

Referring to FIG. 12, a dissembled waterborne payload transport system 100 can have multiple elements fastened and stored on one or more pallets. When stored onto a pallet, the elements of the payload transport system can be stored onto or in another vehicle such as a ship, truck or aircraft for in compact form for convenient transport. In an embodiment, multiple beams 210, 220, 230, 240, the arm 410 of the crane element, and the motors 360, 362 of the trolley system are fastened to one or pallets. In an embodiment, one or more base frames 270, 280 and one or more of stowage cradles 510, 512, 514 may also be fastened onto a pallet.

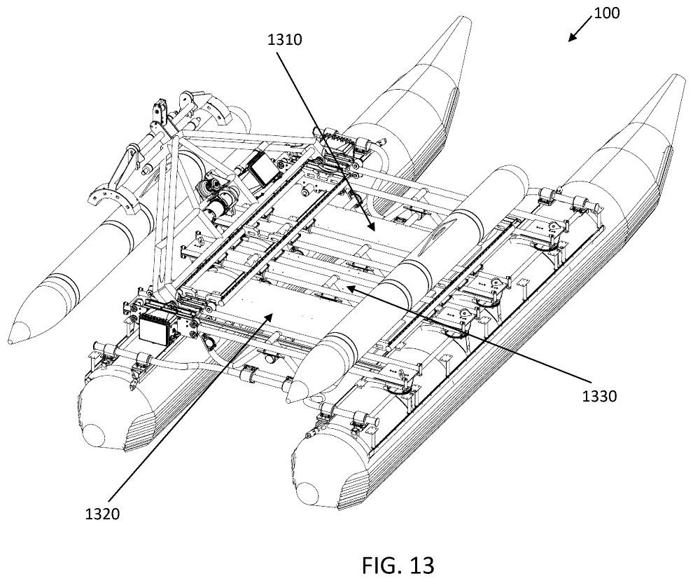

FIG. 13 illustrates an embodiment of the waterborne payload transport system 100 where walkway panels 1310, 1320 and 1330 are generally located between floatation elements 250, 252. The walkway panels 1310, 1320, 1330 provide a generally horizontal platform for a human operator to stand and walk on the waterborne payload transport system 100. Also referring to FIG. 3, the walkway panels 1310, 1320, 1330 may lie between front brace 610 and a rear brace 612 and may lie below tracks 214, 224, 234, 244. The walkway panels 1310, 1320, 1330 may lie between tracks 214 and 244. Each of walkway panels 1310, 1320, 1330 may be comprised of multiple panels. Panel 1310 may lie between tracks 214 and 224. Panel 1330 may be located between tracks 224 and 234. Panel 1320 may be located between tracks 234 and 244. Each of panels 1310, 1320 and 1330 may be comprised of a single element or multiple elements.

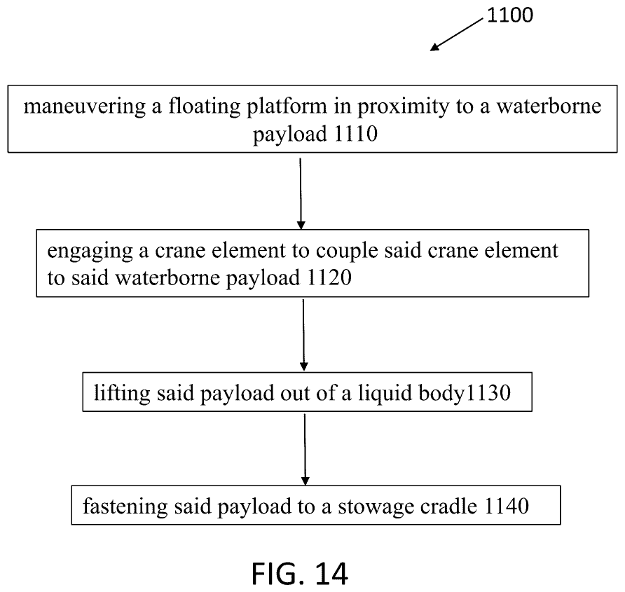

FIG. 14 is a flowchart that illustrates a method of operating a waterborne payload transport system 1100. The method includes maneuvering a floating platform in proximity to a waterborne payload 1110, engaging a crane element to couple the crane element to the waterborne payload 1120, lifting the payload out of a liquid body 1130, and fastening the payload to a stowage cradle 1140. The method of operating a waterborne payload transport system may further include attaching a towline to the floating platform and towing the floating platform with a towing vehicle. The step of engaging a crane element to couple the crane element to the waterborne payload may include rotating an arm about an axis from a first position to a second position below the first position. The step of fastening the payload to a receiver including moving the payload along a rail and lowering the payload into the stowage cradle.

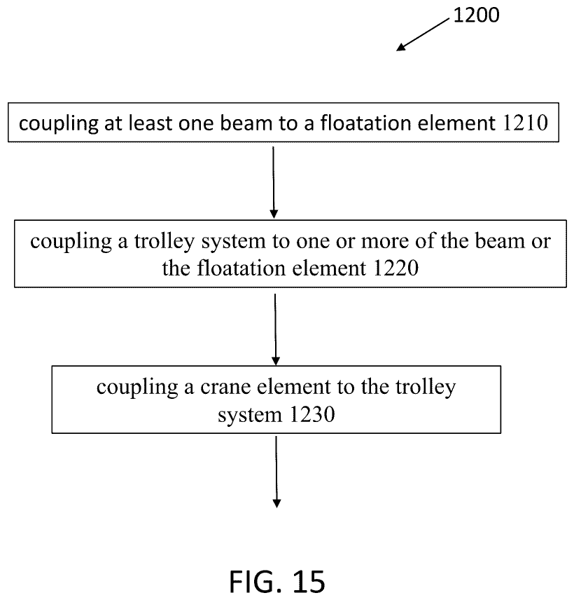

FIG. 15 is a flowchart that illustrates a method of assembling and disassembling a waterborne payload transport system 1200 including coupling one or more beams to a floatation element 1210, coupling a trolley system to one or more of the beams or the floatation element 1220, and coupling a crane element to the trolley system 1230. The method of assembling and disassembling a waterborne payload transport system may further include coupling a stowage cradle to any one of the beam or to the trolley system. The method of assembling and disassembling a waterborne payload transport system may further include decoupling at least one beam from the floatation element, decoupling the trolley system from one or more of the beam or the floatation element, and decoupling said crane element from said trolley system. The method of assembling and disassembling a waterborne payload transport system may further include fastening the beam, the arm of the crane element, and the motors of the trolley system to a pallet and transporting the pallet. The pallet may be loaded onto a transport such as a ship, a truck or a plane allowing for multiple options to transport the waterborne payload transport system in a compact form. The floating element may be inflatable and may be deflated to provide a compact form for transportation by another vehicle.

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Finally, terms of degree such as “substantially”, “about” and “approximately” as used herein mean a reasonable amount of deviation of the modified term such that the end result is not significantly changed.

From the above description of the Waterborne Payload Transport System, it is manifest that various techniques may be used for implementing the concepts without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that the systems and methods are not limited to the particular embodiments described herein, but is capable of many embodiments without departing from the scope of the claims.

I/We claim:

1. A waterborne payload transport system comprising:
a floating platform;
a trolley system having at least one track coupled to said floating platform; and
a crane element having at least one arm, the crane element moveably coupled to said trolley system.

2. The waterborne payload transport system of claim 1 where the floating platform comprises at least one flotation element.

3. The waterborne payload transport system of claim 1 where the trolley system comprises at least one motor that engages said track to move said crane along the track.

4. The waterborne payload transport system of claim 1 where the arm is pivotably coupled at a base to at least one of said track or to a motor.

5. The waterborne payload transport system of claim 1 where the crane element comprises a holder coupled to an end of said arm, the holder adapted to interface with a payload.

6. The waterborne payload transport system of claim 1 further comprising a tow interface.

7. The waterborne payload transport system of claim 1 where the floating platform comprises at least one beam that extends between at least two flotation elements.

8. The waterborne payload transport system of claim 1 where the floating platform includes at least one base frame comprising a plurality of lateral joists that are complimentary in shape to a top portion of a flotation element and a plurality of longitudinal linkages which couples said lateral beams.

9. The waterborne payload transport system of claim 8 where the frame further comprises a plurality of mounts for coupling a plurality of beams that extend between two floatation elements.

10. The waterborne payload transport system of claim 1 where further comprising a stowage cradle adapted to receive a payload and secure said payload.

11. The waterborne payload transport system of claim 2 where the floating platform comprises a beam that is detachably coupled to said flotation element.

12. The waterborne payload transport system of claim 1 where the crane element is detachably coupled to the trolley system.

13. A method of operating a waterborne payload transport system comprising:
maneuvering a floating platform in proximity to a waterborne payload;
engaging a crane element to couple said crane element to said waterborne payload;
lifting said payload out of a liquid body; and
fastening said payload to a stowage cradle.

14. The method of operating a waterborne payload transport system of claim 13 further comprising attaching a tow line to said floating platform and towing said floating platform with a towing vehicle.

15. The method of operating a waterborne payload transport system of claim 13 where engaging a crane element to couple said crane element to said waterborne payload comprises rotating an arm about an axis from a first position to a second position below said first position.

16. The method of operating a waterborne payload transport system of claim 13 where fastening said payload to a receiver comprises moving said payload along a rail and lowering said payload into said stowage cradle.

17. A method of assembling and disassembling a waterborne payload transport system comprising
coupling at least one beam to a floatation element;
coupling a trolley system to one or more of said beam or said floatation element; and
coupling a crane element to said trolley system.

18. The method of assembling and disassembling a waterborne payload transport system of claim 17 further comprising coupling a stowage cradle to any one of said beam or said trolley system.

19. The method of assembling and disassembling a waterborne payload transport system of claim 18 further comprising decoupling at least one beam from said floatation element, decoupling the trolley system from one or more of said beam or said floatation element, and decoupling said crane element from said trolley system.

20. The method of assembling and disassembling a waterborne payload transport system of claim 19 further comprising fastening said beam, an arm of said crane element, and at least one motor of said trolley system to a pallet and transporting said pallet.
